(19) United States
(12) Patent Application Publication
(10) Pub. No.: US 2008/0295586 A1
(43) Pub. Date: Dec. 4, 2008

(54) Fuel Tracking System

(76) Inventor: Dwayne Fosseen, Radcliffe, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/130,098

(22) Filed: May 30, 2008

Related U.S. Application Data
(60) Provisional application No. 60/932,202, filed on May 30, 2007.

(51) Int. Cl. G01M 15/04

(52) U.S. Cl. 73/114.14; 73/114.53; 73/114.52; 701/213

(57) ABSTRACT

An apparatus for real-time monitoring of fuel consumption of a vehicle is provided. The apparatus includes a fuel sensor in operative communication with a data tracker for logging set increments. The fuel consumption information is sent to a remote communication device that is in communication with the data tracker, and then the fuel consumption information is sent to a remote monitoring network, where reports detailing fuel consumption are generated. The fuel consumption data provides a user with information about hourly fuel usage, average horse power, operator performance, the location where each increment of fuel is consumed, excessive idle times or breaks in production, and differences in fuel consumption rates for different operators, shifts and jobs.

### BACKGROUND OF THE INVENTION

The invention relates generally to an apparatus for analysis of the fuel usage of individual vehicles, and in particular to the remote communication of data regarding fuel consumption for an individual vehicle for the purpose of analyzing how the vehicle consumes fuel.

With the rising cost of fuel, the need exists to monitor how an individual vehicle uses fuel. Information about how a particular vehicle, and each individual vehicle in a fleet of vehicles, consumes fuel can be used to alter or improve use of a vehicle in order to improve the fuel efficiency of that vehicle.

Monitoring of fuel consumption and vehicle use can provide a user with a wealth of information about a particular vehicle. For example, if a user has data about hourly fuel usage, average horse power, operator performance, the location where each increment of fuel is consumed, identify excessive idle times or breaks in production, differences in fuel consumption rates for different operators, shifts and jobs, changes can be made in how the vehicle is operated and by whom that can improve fuel efficiency.

For example, it is known that individual driver performance can vary dramatically and have a substantial impact on fuel economy. A particular operator may spend unnecessary time with a vehicle idling or at speeds that are inefficient. If the employer/fleet manager obtains data demonstrating the excess idle time, etc. and the driver is reprimanded, the driver's operation of the vehicle may consequently improve, as will the fuel economy of the vehicle.

Thus the need exists for a method and apparatus for the real-time communication of fuel consumption.

### SUMMARY OF THE INVENTION

An object of the present invention comprises providing a method and apparatus for real-time communication of fuel consumption of an individual vehicle.

These and other objects of the present invention will become apparent to those skilled in the art upon reference to the following specification, drawings, and claims.

The present invention intends to overcome the difficulties encountered heretofore. To that end, an apparatus for remote communication of data regarding real-time fuel consumption of a particular vehicle is provided. The invention comprises a data tracker in operative communication with both a fuel sensor and a remote communication device.

### BRIEF DESCRIPTION OF THE DRAWINGS

FIG. 1 is a diagram of the fuel tracking system of the present invention.

FIG. 2 is a report of the present invention showing a particular vehicle's weekly fuel usage and emissions.

FIG. 3 is a report of the present invention showing the fuel consumption of a vehicle over one day.

FIG. 4 is a report of the present invention showing a satellite-generated map of the location of a particular vehicle and the fuel consumed over one day.

FIG. 5 is a report of the present invention showing satellite-generated map of the location of a particular vehicle and the fuel consumed over one day.

FIG. 6 is a report of the present invention showing specific fuel consumption for one month.

FIG. 7 is a report of the present invention showing specific fuel consumption for one day.

### DETAILED DESCRIPTION OF THE INVENTION

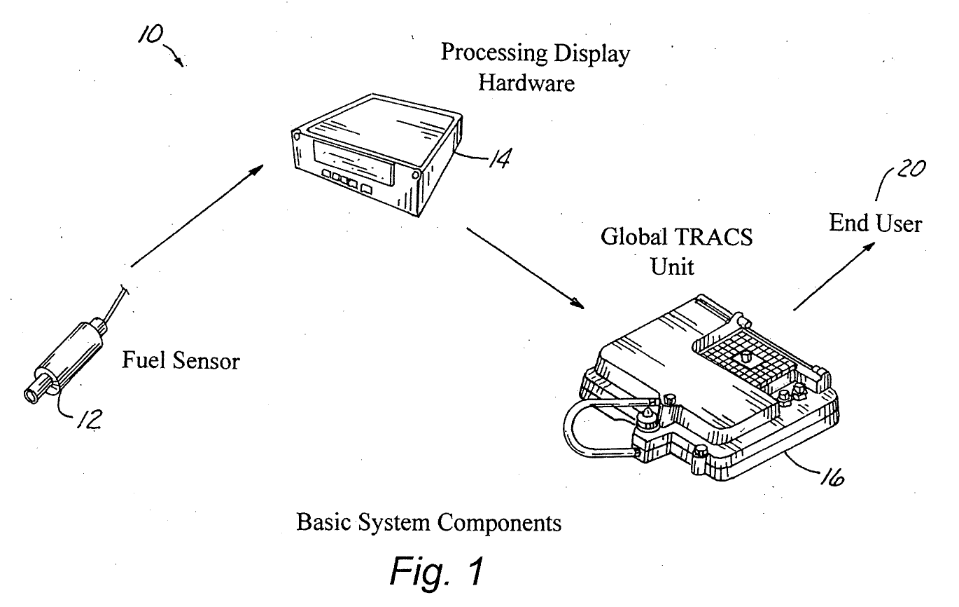

The fuel tracking system 10 of the present invention is shown in FIG. 1. The invention comprises a pressure transducer 12 coupled with processing and display hardware 14, which outputs data to a remote communication device 16. The fuel tracking system 10 allows a user to monitor actual, real-time fuel usage in an individual vehicle or in a fleet of vehicles. The system allows monitoring of data such as hourly fuel usage, average horsepower, operator performance, tracking the location of each gallon of fuel consumed, excessive idle time, breaks in production, and differences in fuel consumption rates for different operators, shifts and jobs. The system uses a diesel engine's intake air pressure to determine the engine's real-time fuel consumption.

A fuel sensor 12 is installed on the pressure side of the turbocharger of the engine measuring the intake manifold pressure. The sensor 12 is installed in a location downstream of the turbo outlet, up to and including the intake manifold of the engine. Any location that is suitable for mounting and provides an uninterrupted supply of intake air pressure is acceptable for mounting the sensor 12. Sensor 12 installation requires a suitable location for mounting and room for a cable to be connected and routed to the display meter 14. Usually the sensor 12 can be mounted directly on the intake manifold. Unused ports on the intake manifold are suited for installation of the sensor. The sensor output signal is configured according to the vehicle's operating characteristics.

The sensor output is sent to a processing meter 14 for processing and display. In one embodiment, the processing meter used is the Model CUB5P Miniature Electronic 5-Digit Process Meter made by Red Lion. This Red Lion processing meter 14 has been modified, as a totalizer function has been added. The meter 14 totalizes the fuel usage up to the set unit of measure. Once the set unit of measure has been reached, the unit sends a signal to the GPS unit. For example, the unit will send a signal for every quart, half gallon, or gallon of fuel used, depending on how the unit is calibrated and also based on the size of the engine. The processing meter 14 includes a display that provides a readout indicating the fuel consumption rate. The display meter 14 is placed in an interior location, generally inside the operator's cab. The display meter 14 may be placed in view of the vehicle operator, but also may be hidden from the operator's view.

As the processing meter 14 logs the events (i.e., the set amount of fuel has been consumed), the events are sent to the remote communication device 16. In one embodiment, the remote communication device 16 used is a GPS unit, and specifically the Qualcomm GlobalTRACS unit.

Real-time engine fuel usage is sent through the remote communication device 16 to any remote monitoring network 20. For example, the information can be sent to any computer that has been designated for monitoring a particular vehicle. The information sent to the remote communication device 16 can be used in numerous reports for the vehicle.

A global positioning satellite receiver is placed on the vehicle for providing information regarding the position of the vehicle. This information is also sent to the remote communication device 16 and sent to the remote monitoring network 20. This positioning information can be used in conjunction with the fuel consumption information to generate reports regarding the specific location of where each increment of fuel is consumed.

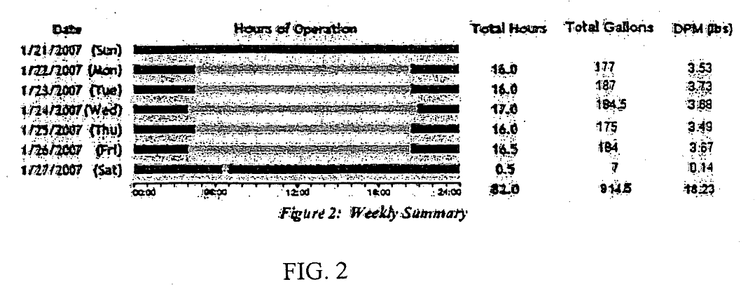

One example of a report generated from the information logged by the system simply measures daily fuel consumption for an individual vehicle. As shown in FIG. 2, the system, over the course of a week, measured specific hours the vehicle was operated, the total hours the vehicle was operated, the total hours the vehicle was operated, the total gallons of fuel used, and the emissions.

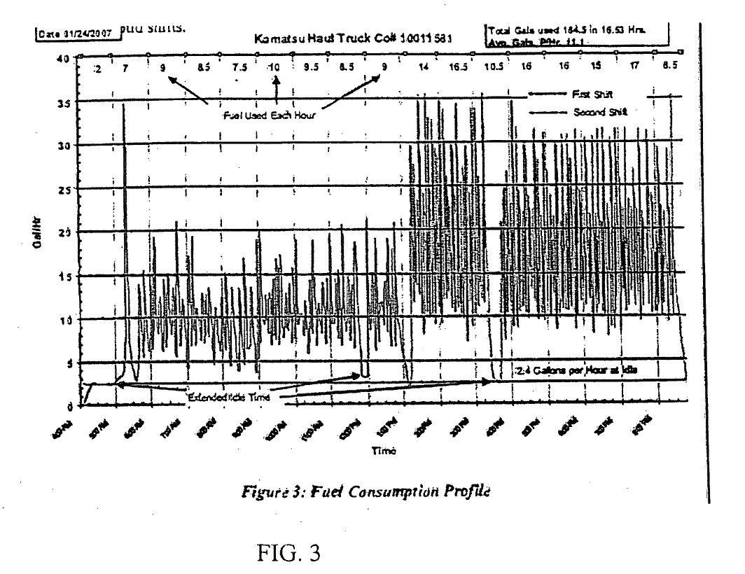

Another more detailed report that can be generated is shown in FIG. 3. FIG. 3 analyzes the same mine haul truck as in FIG. 2, in this instance looking specifically at the same Wednesday. In FIG. 2, the weekly summary shows the vehicle running for a period of 17 hours, consuming 186.5 gallons of fuel, but does not provide detailed information about the specific work done by the truck on a particular day. FIG. 3 details the horsepower generated over the day, and compares two shifts. In the first shift, the worker generated 3,990 tons of production and had two periods of extended idle time. During the second shift, the second worker generated 5,880 tons of production, with extended idle time. The owner of the vehicle can use this information to schedule more efficient workers or encourage the more inefficient workers to increase production.

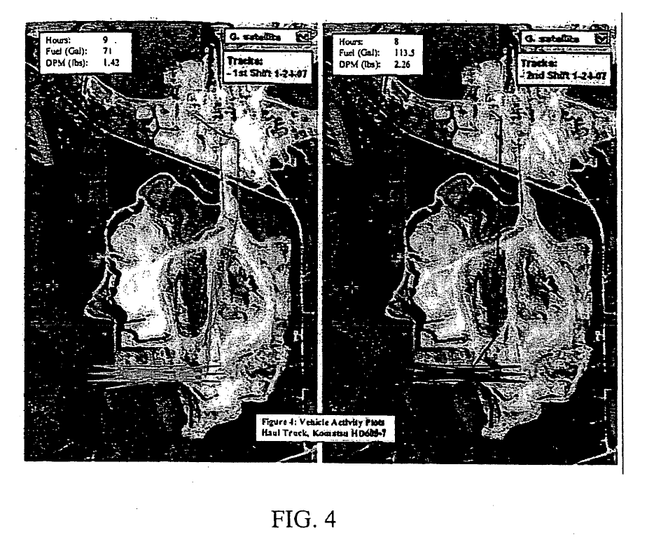

A further report is seen in FIG. 4, which shows a detailed GPS plot for the same mine haul truck in FIGS. 2 and 3, during the same day as FIG. 3. FIG. 4 shows that the two different operators during the tow shifts were working the same job, hauling in the same locations. Because of the detail provided in FIG. 3, the fleet operator knows that the differences in consumption must be based on the operators, because they were working the same job.

The tracking system can be combined with other devices that measure emissions. The vehicle described in FIGS. 2 and 4 was also equipped with such a device, and the report includes by the mine haul trick during each shift.

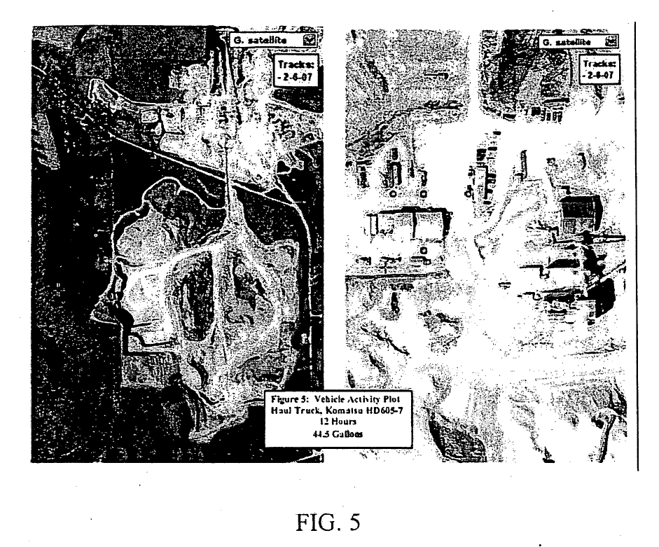

The system can provide fleet management with numerous tools to observe, track and modify performance in order to produce the most efficient and cost effective operation. FIG. 5 illustrates a further use of the information from the system. The date collected and processed shows the real-time location of the same mine haul truck tow weeks after the reports of FIG. 2-4. The truck ran for a period of twelve hours and consumed over 44 gallons of fuel, yet, as seen in FIG. 5, the vehicle never left the maintenance building and thus idled for twelve hours. This information, while troubling to fleet management, was very useful for identifying personnel issues.

Using the system of the present invention, a user has access to information to determine fuel consumption rates for specific jobs, total fuel usage, location, time and duration of production or excess idling and breaks. The system monitors the average horsepower used by a machine, allowing a user to effectively pair vehicles with each other and their related jobs.

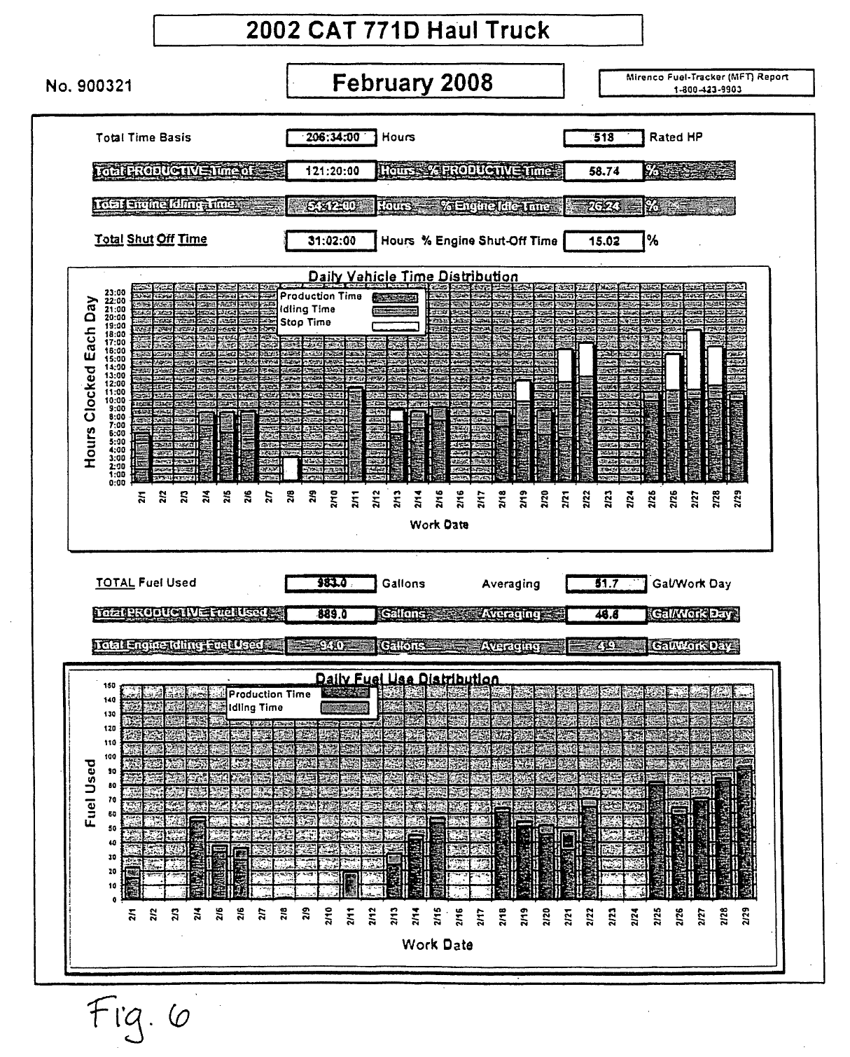

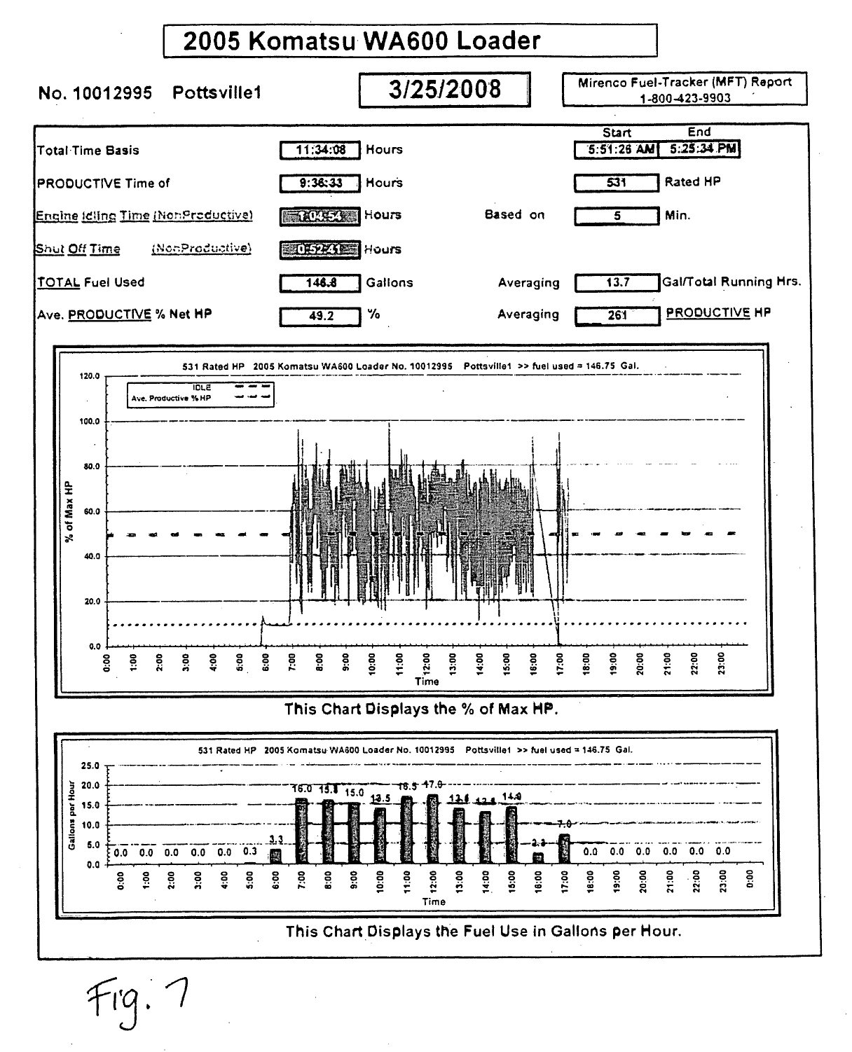

FIGS. 6 and 7 show additional reports. FIG. 6 reports the production time, idling time and stop time of a vehicle every day for a month. Analyzing the horsepower, the percent productive time, idle time and engine shut-off time is also shown and the information is processed to show the daily fuel consumed over the course of a month, and provides an average amount of fuel consumed per day during both productive time and idle time. FIG. 7 shows specific details of fuel consumption over the course of one day.

The invention is also contemplated to be used to monitor other criteria, including fuel filters, the exhaust manifold, exhaust emissions, and the accelerometer.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example a datalogger could be used in place of the GPS unit. Also a similar system for obtaining real-time fuel consumption information could also be used for non-turbocharged engine vehicles. In the example of a non-turbocharged engine, a thermocoupler would be employed in the place of a fuel sensor.

1. An apparatus for real-time monitoring of the fuel consumption of a vehicle comprising:
a) a fuel sensor;
b) a data tracker in operative communication with said fuel sensor for tracking fuel consumption parameters;
c) a remote communication device in operative communication with said data tracker for communicating said fuel consumption; and
d) a remote monitoring network for receiving said fuel consumption parameters from the remote device and for generating a report using said fuel consumption parameters.

2. The apparatus of claim 1, wherein the report includes the amount of fuel consumed over a selected time period.

3. The apparatus of claim 1, wherein the report includes the horsepower used by the vehicle over a selected time period.

4. The apparatus of claim 1, wherein said remote communication device utilizes cellular communications.

5. The apparatus of claim 1, wherein said remote communication device utilizes satellite communication.

6. The apparatus of claim 1, wherein said remote communication device utilizes a radio transmitter and receiver.

7. The apparatus of claim 1, wherein said remote communication device utilizes a wireless modem.

8. The apparatus of claim 1, further comprising a global positioning satellite receiver on said vehicle for receiving satellite signals that provide information regarding a position of said vehicle, said remote communication device is in operative communication with said global positioning satellite receiver for communicating said vehicle position information, and said remote monitoring network receives said vehicle position information from said remote communication device.

9. The apparatus of claim 8, wherein the report includes a map of where each parameter of fuel was consumed.
